(19) United States
(12) Patent Application Publication
(10) Pub. No.: US 2013/0059963 A1
(43) Pub. Date: Mar. 7, 2013

(54) COATING COMPOSITION AND APPLICATIONS THEREOF

(71) Applicants: Kuang-Chieh Li, Kaohsiung City (TW); Bo-Hsuan Lin, Tainan City (TW)

(72) Inventors: Kuang-Chieh Li, Kaohsiung City (TW); Bo-Hsuan Lin, Tainan City (TW)

(21) Appl. No.: 13/592,519

(22) Filed: Aug. 23, 2012

(30) Foreign Application Priority Data
Sep. 7, 2011 (TW) 100132242

(51) Int. Cl. C09D 153/02; B05D 3/00

(52) U.S. Cl. 524/502; 427/58

(57) ABSTRACT

A coating composition includes a block copolymer, an adhesive resin, and a solvent for dispersing the block copolymer and the adhesive resin therein. The block copolymer contains at least two vinyl aromatic polymer blocks and at least one partially hydrogenated conjugated diene polymer block, and has a hydrogenation ratio ranging from 10% to 90%.

### CROSS-REFERENCE TO RELATED APPLICATION

This application claims priority of Taiwanese Application No. 100132242, filed on Sep. 7, 2011.

### BACKGROUND OF THE INVENTION

1. Field of the Invention

This invention relates to a coating composition, more particularly to a coating composition for making a moisture-proof insulating film for an electronic device. This invention also relates to a moisture-proof insulating film formed from the coating composition and a moisture-proof insulating electronic device containing the film.

2. Description of the Related Art

An electronic device is usually required to have characteristics of miniaturization and multi-functionality, and the circuit design for the electronic device tends to be more complicated. The insulation and moisture-proof properties of the electronic device are key factors that may affect the lifespan of the electronic device. Therefore, a coating layer is usually provided on the electronic device so as to protect the electronic device from moisture, dust, or the like.

JP2005-132966 discloses an insulating coating which includes an acrylic resin and polyolefin elastomer or polyurethane as main components and n-butyl acetate as a solvent so as to solve the environmental problem attributed to use of a highly toxic solvent.

JP2005-126456 discloses a moisture-proof insulating coating which comprises 10-40 parts by weight of a thermoplastic resin, 1-20 parts by weight of a pressure-sensitive adhesion imparting resin, 0.1-5 parts by weight of a silane coupling agent, and 50-90 parts by weight of a solvent. The moisture-proof insulating coating disclosed in JP2005-126456 is intended to solve the problem of an inferior moisture-proof property of the prior electronic device caused by the moisture permeating through a coating film at a high temperature and humidity environment and present between the coating film and the electronic device.

JP2008-189763 discloses an insulating coating which includes an A-B-A type styrenic block copolymer and/or its hydride, a stickifier resin, and 50-150 parts by weight of a solvent. It is intended to solve the problem of an inferior bonding property of a prior insulating film with a substrate over a long period, which leads to a problem of an inferior insulating property of an electronic device.

It is desirable in the art to further improve the properties such as film evenness, reworkability, and adhesion of an insulating film for an electronic device.

### SUMMARY OF THE INVENTION

Therefore, a first object of the present invention is to provide a coating composition having superior coating evenness.

A second object of the present invention is to provide a moisture-proof insulating film having superior reworkability, adhesion, and moisture-proof properties.

A third object of the present invention is to provide a moisture-proof insulating electronic device including the moisture-proof insulating film.

A fourth object of the present invention is to provide a method for manufacturing the moisture-proof insulating electronic device.

According to a first aspect of this invention, there is provided a coating composition including a block copolymer, an adhesive resin, and a solvent for dispersing the block copolymer and the adhesive resin therein. The block copolymer contains at least two vinyl aromatic polymer blocks and at least one partially hydrogenated conjugated diene polymer block, and has a hydrogenation ratio ranging from 10% to 90%.

According to a second aspect of this invention, there is provided a moisture-proof insulating film formed from the coating composition.

According to a third aspect of this invention, there is provided a moisture-proof insulating electronic device including the moisture-proof insulating film.

According to a fourth aspect of this invention, there is provided a method for manufacturing the moisture-proof insulating electronic device including the steps of: coating the coating composition on an electronic device, and drying the coating composition to form a moisture-proof insulating film on the electronic device.

### BRIEF DESCRIPTION OF THE DRAWING

Other features and advantages of the present invention will become apparent in the following detailed description of the preferred embodiments with reference to the accompanying drawing, of which:

FIG. 1 is a schematic view showing measured points of a moisture-proof insulating film for measuring thickness of the film.

### DETAILED DESCRIPTION OF THE PREFERRED EMBODIMENTS

The coating composition according to the present invention includes a block copolymer, an adhesive resin, and a solvent for dispersing the block copolymer and the adhesive resin therein. The block copolymer contains at least two vinyl aromatic polymer blocks and at least one partially hydrogenated conjugated diene polymer block, and has a hydrogenation ratio ranging from 10% to 90%.

The hydrogenation ratio of the block copolymer can be determined through nuclear magnetic resonance (NMR), and can be controlled by adjusting the period for hydrogenation reaction, the amount of hydrogenation catalyst, the amount of hydrogen, or the like.

The hydrogenation ratio ranges preferably from 15% to 85% and more preferably from 20% to 80%.

When the hydrogenation ratio is less than 10%, the reworkability of a moisture-proof insulating film formed from the coating composition is unsatisfactory. When the hydrogenation ratio is more than 90%, the adhesion of the moisture-proof insulating film is inferior.

### Block Copolymer:

The block copolymer used in the present invention contains at least two vinyl aromatic polymer blocks and at least one partially hydrogenated conjugated diene polymer block.

Preferably, the vinyl aromatic polymer block is produced from polymerization of a vinyl aromatic monomer. The vinyl aromatic monomer is at least one compound selected from (1) unsubstituted or alkyl-substituted styrene compounds, such as styrene, 2-methylstyrene, 3-methylstyrene, 4-methylstyrene, 4-ethylstyrene, 4-tert-butylstyrene, 2,4-dimethylstyrene, α-methylstyrene, α-methyl-4-methylstyrene, or the like; and (2) halogen-substituted styrene compounds, such as 2-chlorostyrene, 4-chlorostyrene, or the like.

Preferably, the conjugated diene polymer block is produced from polymerization of a conjugated diene monomer. The conjugated diene monomer is at least one compound selected from 1,3-butadiene, 2-methyl-1,3-butadiene, 2-methyl-1,3-isopentadiene, 2,3-dimethyl-1,3-butadiene, 1,3-pentadiene, 1,3-hexadiene, or the like.

The block copolymer can be synthesized by a process including the steps of (1) polymerization reaction: the vinyl aromatic monomer and the conjugated diene monomer are respectively dissolved in an organic solvent and a polymerization initiator is then added so as to initiate an anionic polymerization reaction to form a block copolymer precursor; and (2) hydrogenation reaction: the block copolymer precursor is hydrogenated in the presence of a hydrogenation catalyst to form the block copolymer.

### (1) Polymerization Reaction:

Preferably, the vinyl aromatic monomer and the conjugated diene monomer are respectively diluted with an organic solvent to a proper concentration before mixing and polymerizing these monomers. In the following examples, the vinyl aromatic monomer and the conjugated diene monomer are respectively diluted to a concentration of 25 wt %.

Preferably, the organic solvent is selected from: (1) aliphatic compounds, such as n-butane, isobutane, n-pentane, n-hexane, n-heptane, n-octane, or the like; (2) cycloaliphatic compounds, such as cyclopentane, methylcyclopentane, cyclohexane, methylcyclohexane, cycloheptane, methylcycloheptane, or the like; or (3) combinations thereof. Aromatic compounds such as benzene, toluene, xylene, ethylbenzene, or the like can be used as the organic solvent for producing the block copolymer as long as the polymerization reaction is not negatively affected.

There is no specific limitation to the polymerization initiator. Commonly used organic alkaline metal compounds can be used as the polymerization initiator. Examples of the organic alkaline metal compounds include, but are not limited to, aliphatic alkaline metal compounds, aromatic alkaline metal compounds, organic amino alkaline metal compounds, or the like. Preferably, the polymerization initiator is selected from C₁-C₂₀ aliphatic lithium compounds, C₆-C₂₀ aromatic lithium compounds, C₁-C₂₀ aliphatic sodium compounds, C₆-C₂₀ aromatic sodium compounds, C₁-C₂₀ aliphatic potassium compounds, C₆-C₂₀ aromatic potassium compounds, or combinations thereof.

Examples of the C₁-C₂₀ aliphatic lithium compounds include, but are not limited to, n-propyl lithium, n-butyl lithium, sec-butyl lithium, tert-butyl lithium, hexamethylene dilithium, butadienyl dilithium, and isopentadienyl dilithium. Examples of the C₆-C₂₀ aromatic lithium compounds include, but are not limited to, a reaction product of diisopropenyl benzene and sec-butyl lithium, and a reaction product of divinyl benzene, sec-butyl lithium, and a minor amount of 1,3-butadiene. Additionally, the organic alkaline metal compounds disclosed in U.S. Pat. No. 5,708,092, UK patent No. 2,241,239, and U.S. Pat. No. 5,527,753 can be used. The aforesaid examples of the polymerization initiator may be used alone or in admixture of two or more.

The polymerization temperature ranges preferably from −10° C. to 150° C., and more preferably from 40° C. to 120° C. The polymerization time can be adjusted according to the polymerization temperature, and is preferably no more than 10 hours, and more preferably from 0.5 hour to 5 hours. Preferably, the polymerization reaction is conducted under an inert atmosphere, such as a nitrogen atmosphere. There is no specific limitation to polymerization pressure as long as the vinyl aromatic monomer, the conjugated diene monomer, and the solvent are maintained at a liquid state at the polymerization temperature. It should be noted that impurities (for example, water, oxygen, carbonic acid gas, or the like) rendering the polymerization initiator and living polymer inert should not be present in the polymerization reaction.

### (2) Hydrogenation Reaction:

There is no specific limitation to the hydrogenation catalyst. The following commonly used catalyst can be used in the present invention: (1) a supported type heterogeneous hydrogenation catalyst in which a metal is supported on a porous inorganic material; (2) a Ziegler type hydrogenation catalyst using an organic acid salt or a transition metal salt and a reducing agent; (3) organic metal compounds; (4) organic metal complexes; or the like.

Examples of the hydrogenation catalyst include, but are not limited to, (1) a supported type heterogeneous hydrogenation catalyst in which a metal such as Ni, Pt, Pd or Ru is supported on a carbon, silica, alumina, diatomaceous earth or the like; (2) a Ziegler type hydrogenation catalyst using an organic acid salt of Ni, Co, Fe, Cr or the like or a transition metal salt such as an acetylacetone salt and a reducing agent such as an organoaluminum; (3) an organic metal compound of Ti, Ru, Rh, Zr or the like; and (4) an organic metal complex of Ti, Ru, Rh, Zr or the like. As for the hydrogenation catalysts, the hydrogenation catalysts described in JP-B-42-8704, JP-B-43-6636, JP-B-63-4841, JP-B-1-37970, JP-B-1-53851, and JP-B-2-9041 may be used. Preferred examples of the hydrogenation catalysts include an organic metal complex of titanocene, a reducing organic metal compound, or a combination thereof.

As for the organic metal complex of titanocene, the complexes described in JP-A-8-109219 may be used. Specific examples thereof include a complex having at least one ligand having a (substituted) cyclopentadienyl skeleton, an indenyl skeleton or a fluorenyl skeleton, such as biscyclopentadienyltitanium dichloride or monopentamethylcyclopentadienyltitanium trichloride. Further, examples of the reducing organic metal compounds include, but are not limited to, an organic alkali metal compound such as an organolithium, an organomagnesium compound, an organoaluminum compound, an organoboron compound, an organozinc compound, or the like.

Preferably, the hydrogenation reaction is generally conducted within the temperature range of 0° C. to 200° C., more preferably 30° C. to 150° C. The pressure of hydrogen used in the hydrogenation reaction is preferably from 0.1 MPa to 15 MPa, more preferably from 0.2 MPa to 10 MPa, and most preferably from 0.3 MPa to 7 MPa. The hydrogenation reaction time is preferably from 3 minutes to 10 hours, and more preferably from 10 minutes to 5 hours. In the hydrogenation reaction, any one of a batch process, a continuous process and a combination thereof can be used.

The vinyl aromatic monomer unit contained in the block copolymer is in an amount ranging preferably from 15 wt % to 60 wt %, more preferably from 18 wt % to 57 wt %, and most preferably from 20 wt % to 55 wt %, based on 100 wt % of the block copolymer. When the vinyl aromatic monomer unit contained in the block copolymer is in the amount defined above, a moisture-proof insulating film made of the coating composition has superior reworkability and adhesion.

The block copolymer has a number average molecular weight ranging preferably from 50,000 to 100,000, more preferably from 52,000 to 980,000, and most preferably from 55,000 to 950,000. When the number average molecular weight of the block copolymer is in the range defined above, the coating composition has superior coating evenness.

### Adhesive Resin:

The adhesive resin is used to enhance the adhesion of the moisture-proof insulating film made of the coating composition with a substrate.

There is no specific limitation to the adhesive resin. It is generally selected from a petroleum resin, a rosin resin, and a terpene resin. The resins are soluble in a solvent.

Preferably, the petroleum resin is selected from an aliphatic petroleum resin, an aromatic petroleum resin, a cycloaliphatic petroleum resin, an aliphatic/aromatic copolymer petroleum resin, hydrogenated derivatives thereof, or combinations thereof.

Commercially available products suitable for the petroleum resin include, for example, ARKON P, ARKON M, or the like manufactured by Arakawa Chemical Industries, Ltd.; escorez, tohopetorosin, or the like manufactured by Tonen Chemical Corp.; Hi-rez, takace, FTR, or the like manufactured by Mitsui Chemicals Co., Ltd.; Quintone, or the like manufactured by Nippon Zeon; wingtak or the like manufactured by Goodyear; startak or the like manufactured by Dainippon Ink and Chemicals Inc.; or combinations thereof.

Preferably, the rosin resin is selected from rosin resin and derivatives thereof, rosin modified resin, or combinations thereof, and can be obtained from natural rosins and polymerized rosins. Examples of the rosin resin suitable for the present invention include ester rosin such as pentaerythritol ester rosin and glycerine ester rosin, and hydrogenated derivatives thereof. Commercially available products of the rosin resin include, for example, rosin gum, wood rosin, ester gum A, ester gum H, PENSEL A, PENSEL C or the like manufactured by Arakawa Chemical Industries, Ltd.; pentalin A, fooraru AX, fooraru 85, fooraru 105, or pentalin C manufactured by Rika Hercules Co., Ltd; or combinations thereof.

Preferably, the terpene resin is selected from polyterpene, terpene phenolic resin, hydrogenated resin thereof, or combinations thereof. Commercially available products of the terpene resin include, for example, picolight S, picolight A, or the like manufactured by Rika Hercules Co., Ltd; YS resin, YS Polyester-T, Clearon, or the like manufactured by Yasukara Chemical Co., Ltd.; or combinations thereof.

In the examples of the present invention, the commercially available products used as the adhesive resin include, for example, KE311, KE604, P100, P125, P140, M100, M115, M135, A100 S100, 101, 102 or the like manufactured by Arakawa Chemical Industries, Ltd.; YS Resin 10125, YS Resin TR105, YS Resin U130, YS Resin T145, YS Resin T160, CREARON P125, CREARON M115, CREARON K110, CREARON K4090, or the like manufactured by Yasuhara Chemical Co., Ltd.

The soft point of the adhesive resin used in the present invention is not particularly limited, and ranges preferably from 100° C. to 150° C., and more preferably from 110° C. to 140° C. When the soft point of the adhesive resin is in the range defined above, a moisture-proof insulating film made of the coating composition has superior moisture-proof property and adhesion.

The adhesive resin contained in the coating composition of the present invention is in an amount ranging preferably from 5 parts by weight to 200 parts by weight, more preferably from 5 parts by weight to 65 parts by weight, and most preferably from 5 parts by weight to 60 parts by weight, based on 100 parts by weight of the block copolymer. When the amount of the adhesive resin is in the range defined above, a moisture-proof insulating film made of the coating composition has superior adhesion.

### Solvent:

The solvent suitable for the present invention is selected from: (1) ketone compounds, such as acetone, methyl ethyl ketone, or the like; (2) aromatic compounds, such as toluene, xylene, or the like; (3) aliphatic compounds, such as cyclohexane, methylcyclohexane, ethylcyclohexane, or the like; (4) ester compounds, such as methyl acetate, butyl acetate, isopropyl acetate, or the like; (5) alcohol compounds, such as ethanol, butanol, or the like; (6) paraffin compounds, such as paraffin oil, naphthene, or the like; (7) petroleum compound, such as mineral oil, naphtha, DSP 80/100 (manufactured by Exxon Mobil), IP-1016 (manufactured by Idemitsu Kosan, Japan), or the like.

The solvent contained in the coating composition of the present invention is in an amount ranging preferably from 50 parts by weight to 1,000 parts by weight, more preferably from 75 parts by weight to 950 parts by weight, and most preferably from 100 parts by weight to 900 parts by weight, based on 100 parts by weight of the block copolymer. When the amount of the solvent is in the range defined above, the coating composition has superior coating evenness.

In view of the fact that evaporation of the solvent may affect the convenience of the process operation, the boiling point of the solvent used in the present invention ranges preferably from 70° C. to 140° C. When the boiling point of the solvent is in the range defined above, the coating composition has superior coating evenness.

### Siloxane Coupling Agent:

In order to further enhance the adhesion of the moisture-proof insulating film with a substrate, siloxane coupling agent can be added into the coating composition of the present invention. The siloxane coupling agent optionally added in the coating composition of the present invention is in an amount ranging preferably from 0.1 part by weight to 5 parts by weight, more preferably from 0.3 part by weight to 4 parts by weight, and most preferably from 0.5 part by weight to 3 parts by weight, based on 100 parts by weight of the block copolymer.

Examples of the siloxane coupling agent suitable for the present invention include, but are not limited to, vinyltrimethoxysilane, vinyltriethoxysilane, 3-(methyl)acryloxypropyltrimethoxysilane, vinyltri(2-methoxyethoxy)silane, N-(2-aminoethyl)-3-aminopropylmethyldimethoxysilane, N-(2-aminoethyl)-3-aminopropyltrimethoxysilane, 3-aminopropyltriethylsilane, 3-glycidoxypropyltrimethoxysilane, 3-glycidoxypropylmethyldimethoxysilane, 2-(3,4-epoxycyclohexyl)ethyltrimethoxysilane, 3-chloropropylmethyldimethoxysilane, 3-chloropropyltrimethoxysilane, 3-methylallyloxypropyltrimethoxysilane, 3-mercaptopropyltrimethoxysilane, or the like.

Commercially available products of the siloxane coupling agent suitable for the present invention include, but are not limited to, KBM-602, KBM-5103, KBM-503, KBM-1403, KBE-9007, X12-965, or the like manufactured by Shin-Etsu Chemical Co., Ltd.

### Additive:

Various additives may be added into the coating composition of the present invention as long as they do not negatively affect the desirable effects of the coating composition. There is no limitation to the additives, and the additives commonly used in the art may be used in the present invention. The additives include, for example, a filler, a modifier, a defoaming agent, a colorant, a stabilizing agent, a heat-dissipating and insulating material, or the like. The additive optionally added in the coating composition of the present invention is in an amount ranging preferably from 0.1 part by weight to 10 parts by weight based on 100 parts by weight of the block copolymer.

Examples of the filler include, but are not limited to, silica, magnesium oxide, aluminum hydroxide, calcium carbonate, or the like. The filler is preferably used in a powdery form. Examples of the modifier include, but are not limited to, organic metal oxide, such as manganese naphthenate, manganese octenate, or the like. Examples of the defoaming agent include, but are not limited to, silicon oil, fluorine-containing lubricant, polycarboxylic acid, or the like. Examples of the colorant include, but are not limited to, inorganic pigment, organic pigment, organic dye, or the like. Examples of the stabilizing agent include, but are not limited to, octadecyl-3-(3,5-di-tert-butyl-4-hydroxyphenyl) propionate, or the like. Examples of the heat-dissipating and insulating material include, but are not limited to, alumina, aluminum nitride, boron nitride, zinc oxide, or the like. There is no specific limitation to the average particle size of the heat-dissipating and insulating material. Preferably, the average particle size of the heat-dissipating and insulating material ranges from 0.1 μm to 5 μM. The filler, the modifier, the defoaming agent, the colorant, and the stabilizing agent are respectively in an amount ranging from 0.1 part by weight to 10 parts by weight, and the heat-dissipating and insulating material is in an amount ranging from 100 parts by weight to 900 parts by weight, based on 100 parts by weight of the block copolymer.

The coating composition of the present invention is made by dispersing the block copolymer, the adhesive resin, and the optional siloxane coupling agent, and/or the optional additives evenly into the solvent to form a dispersion, and then stirring the dispersion for 3 hours to 24 hours to obtain a solution in a uniform phase.

The viscosity of the coating composition may be adjusted according to the coating and evaporation properties of the coating composition. The viscosity of the coating composition ranges preferably from 0.1 Pa·S to 30 Pa·S, more preferably from 0.1 Pa·S to 20 Pa·S, and most preferably from 0.1 Pa·S to 10 Pa·S. When the viscosity of the coating composition is in the range defined above, the coating composition has superior coating property.

### Moisture-Proof Insulating Film:

The moisture-proof insulating film is made by applying the coating composition of the present invention on a device and then removing the solvent from the coating composition by drying.

The coating composition may be applied using any suitable coating method commonly employed in the art, such as dipping, brushing, spraying, dispenser coating, or the like.

There is no specific limitation to the method of drying as long as the solvent can be removed from the coating composition. Any suitable drying method commonly used in the art can be employed in the present invention. Preferably, the drying temperature ranges from 20° C. to 80° C. There is no specific limitation to the device for coating the coating composition of the present invention. Examples of the device include a circuit board, especially for a thin film transistor liquid crystal display.

### Moisture-Proof Insulating Electronic Device:

An electronic device, for example, a circuit board, is usually mounted with a microprocessor, a transistor, a capacitor, a resistor, a relay, a transformer, or the like. The lead wire, the wire harness, or the like provided on the circuit board is easily damaged due to the moisture and the high temperature, and the quality and lifetime of the electronic device may be reduced thereby. Furthermore, the transistor and the lead wire provided on the circuit board should be treated with a moisture-proof and insulating process so as to avoid electric leakage and short circuit of the electronic device.

The method for manufacturing a moisture-proof insulating electronic device according to the present invention includes the steps of: coating the coating composition of the present invention on an electronic device, and drying the coating composition to form a moisture-proof insulating film on the electronic device.

The suitable coating method and the suitable drying temperature are described above.

### EXAMPLES

The following examples are provided to illustrate the preferred embodiments of the invention, and should not be construed as limiting the scope of the invention.

### Preparation of Block Copolymer:

The hydrogenation catalyst used in the following examples for preparing the block copolymer was prepared as follows. Into a reactor under a nitrogen atmosphere, purified dry cyclohexane (1 L) and bis(η5-cyclopentadiene)titanium dichloride (100 mmol) were added. A n-hexane solution of trimethylaluminum (200 mmol) was then added while stirring to obtain a reaction solution, which was subjected to react at room temperature for 3 days to obtain a hydrogenation catalyst.

### Synthesis Example 1

Into an autoclave equipped with a stirrer, a cyclohexane solution of styrene (15 parts by weight), n-butyl lithium (0.13 part by weight), and tetramethylethylenediamine (0.05 part by weight, as a randomizer) were added under a nitrogen atmosphere. Polymerization reaction was conducted at 70° C. for 20 minutes. A cyclohexane solution of 1,3-butadiene (70 parts by weight) was added into the autoclave over 50 minutes. The polymerization reaction was conducted at 70° C. for further 5 minutes. A cyclohexane solution of styrene (15 parts by weight) was then added, and the polymerization reaction was conducted at 70° C. for further 25 minutes. A block copolymer (A-1) was obtained after the solvent was removed.

### Synthesis Example 2

Into an autoclave equipped with a stirrer, a cyclohexane solution of styrene (20 parts by weight), n-butyl lithium (0.13 part by weight), and tetramethylethylenediamine (0.05 part by weight) were added under a nitrogen atmosphere. Polymerization reaction was conducted at 70° C. for 20 minutes. A cyclohexane solution containing styrene (20 parts by weight) and 1,3-butadiene (30 parts by weight) was then added into the autoclave over 50 minutes. Polymerization reaction was conducted at 70° C. for further 5 minutes. A cyclohexane solution of 1,3-butadiene (15 parts by weight) was then added, and polymerization reaction was conducted at 70° C. for further 5 minutes. A cyclohexane solution of styrene (15 parts by weight) was then added, and polymerization reaction was conducted at 70° C. for further 25 minutes to obtain a reaction solution containing block copolymer precursor. The prepared hydrogenation catalyst was added into the reaction solution in an amount of 0.0015 part by weight based on 100 parts by weight of the block copolymer precursor. Hydrogenation reaction was conducted at 65° C. under at a pressure 0.7 MPa. Methanol and octadecyl-3-(3,5-di-tert-butyl-4-hydroxyphenyl) propionate (0.3 part by weight based on 100 parts by weight of the block copolymer precursor) were added. A block copolymer (A-2) was obtained after the solvent was removed. The hydrogenation ratio of the block copolymer (A-2) is 10%.

### Synthesis Examples 3 to 9

Synthesis Examples 3 to 9 were conducted in a manner identical to that of Synthesis Example 2 using the amounts of the vinyl aromatic monomers, the conjugated diene monomers, and the hydrogenation catalysts shown in Table 1.

TABLE 1

| | | | | | | Total |
|---|---|---|---|---|---|---|
| | Feeding ratio | Amount of | | | | amount of |
| | of the monomers | hydrogenation | | | | vinyl |
| | for block | catalyst | | Structure | | aromatic |
| Syn. | copolymer | (part by | Hydrogenation | of block | | monomer |
| Ex. | (wt %) | weight) | ratio (%) | copolymer | Mn | unit (wt %) |
| 1 | 15-70-15 | 0 | 0 | S-B-S | 66,000 | 30 |
| 2 | 20-20/30-15-15 | 0.0015 | 10 | S-S/B-B-S | 110,000 | 55 |
| 3 | 5-90-5 | 0.0040 | 33 | S-B-S | 47,000 | 10 |
| 4 | 10-20/50-10-10 | 0.0058 | 52 | S-S/B-B-S | 83,000 | 40 |
| 5 | 15-65-20 | 0.0065 | 61 | S-B-S | 72,000 | 35 |
| 6 | 15-15/30-20-20 | 0.0080 | 77 | S-S/B-B-S | 98,000 | 50 |
| 7 | 10-85-5 | 0.0092 | 90 | S-B-S | 52,000 | 15 |
| 8 | 20-30/25-5-20 | 0.0097 | 95 | S-S/B-B-S | 120,000 | 70 |
| 9 | 30/70 | 0.0040 | 40 | S/B | 65,000 | 30 |

S: styrene polymer block;
B: butadiene polymer block;
S/B: styrene/butadiene copolymer block
Mn: Number average molecular weight

### Preparation of Coating Composition

### Example 1

The block copolymer (A-2) obtained in Synthesis Example 2 (100 parts by weight) and adhesive resin (B-1) (Resin U130 manufactured by Yasuhara, 4 parts by weight) were added to cyclohexane (50 parts by weight) to obtain a mixture. The mixture was stirred in a stirrer for 16 hours until complete dissolution to obtain a coating composition. The components and the amounts thereof of the coating composition are shown in Table 2. The coating composition was then evaluated according to the following evaluation methods. The evaluation results are shown in Table 2.

### Examples 2 to 7 and Comparative Examples 1 to 4

Examples 2 to 7 and Comparative Examples 1 to 4 were conducted in a manner identical to that of Example 1 using the block copolymers, the adhesive resins, the solvents, the optional siloxane coupling agents, the optional additives, and the amounts thereof shown in Table 2. The obtained coating compositions of Examples 2 to 7 and Comparative Examples 1 to 4 were then evaluated according to the following evaluation methods. The evaluation results are shown in Table 2.

### Comparative Example 5

Comparative Example 5 was conducted in a manner identical to that of Example 1 except that the block copolymer (A-2) used in Example 1 was replaced with a methacrylic resin manufactured by Chi-Mei Corporation (CM-211) and that the adhesive resin, the solvent, and the amounts thereof shown in Table 2 were used. The obtained coating composition of Comparative Example 5 was then evaluated according to the following evaluation methods. The evaluation results are shown in Table 2.

### Evaluation Items:

### 1. Hydrogenation Ratio of Block Copolymer:

The block copolymers obtained in Synthesis Examples 1 to 9 were measured using a NMR spectrometer (DPX-400, manufactured by Bruker, Germany), and the hydrogenation ratios of the block copolymers were calculated.

### 2. Number Average Molecular Weight of Block Copolymer:

The number average molecular weights of the block copolymers obtained in Synthesis Examples 1 to 9 were determined using a gel permeation chromatograph, Model # HLC-8220 GPC, manufactured by Tosoh Corporation, Japan under the following conditions:

Column: TSK-GELHHR,

Solvent: tetrahydrofuran, and

Synthesis temperature: 35° C.

The intensity in the measured range of the gel permeation was integrated. An integral molecular weight distribution curve was obtained by plotting weight percentage as ordinate versus molecular weight as abscissa. A calibration curve was then obtained by using polystyrene standards having different molecular weight. The number average molecular weights of the block copolymers were then calculated.

### 3. Amount of Vinyl Aromatic Monomer Unit Contained in Block Copolymer:

The block copolymers obtained in Synthesis Examples 1 to 9 were respectively dissolved in chloroform (100 ml). Absorbance was measured using a UV/visible spectrometer. A calibration curve was obtained using standards having different concentrations. The amounts of the vinyl aromatic monomer units respectively contained in the block copolymers of Synthesis Examples 1 to 9 were calculated.

### 4. Coating Evenness:

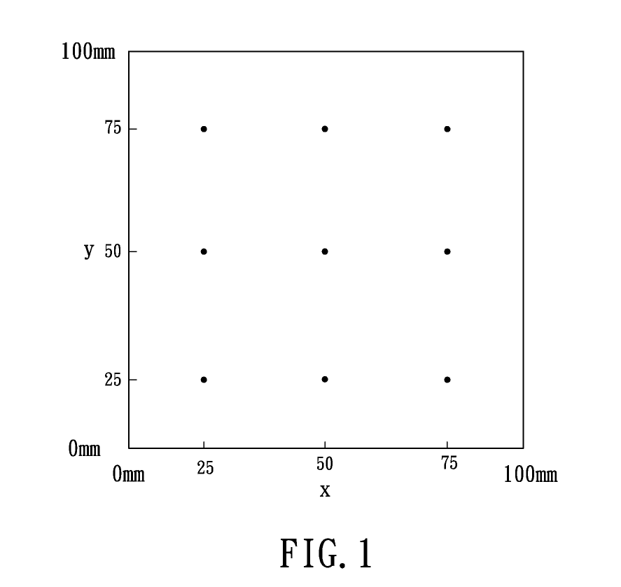

Each of the coating compositions obtained in Examples 1 to 7 and Comparative Examples 1 to 5 was applied on a glass substrate of 100 mm×100 mm using a dispenser (ES-300SR, manufactured by Ever Sharp Technology Co., Ltd.) to form a moisture-proof insulating film on the glass substrate after standing at room temperature for 5 minutes. The thickness values of the moisture-proof insulating film at the measuring points shown in FIG. 1 were measured using a Tencor α-step styrus-based surface profiler. The coating evenness was determined according to the following equation:

$$Coating Evenness = \frac{{FT ( x , y )}_{max} - {FT ( X , y )}_{min}}{2 \times FT ( ave )} \times 100 \%$$

wherein

FT(ave) is an average of the thickness values measured at the measuring points whose coordinates are (25,25), (50,25), (75,25), (25,50), (50,50), (75,50), (25,75), (50,75), and (75,75);

FT(x,y)ₘₐₓ is a maximum of the thickness values measured at the aforesaid measuring points; and

FT(x,y)ₘᵢₙ is a minimum of the thickness values measured at the aforesaid measuring points.

◯: coating evenness 3%

Δ: 3%<coating evenness 5%

X: 5%<coating evenness

### 5. Reworkability:

Each of the coating compositions obtained in Examples 1 to 7 and Comparative Examples 1 to 5 was applied on a glass substrate of 100 mm×100 mm using a dispenser to form a moisture-proof insulating film of 3 mm×100 mm on the glass substrate after standing at room temperature for 5 minutes to evaporate solvent. The moisture-proof insulating film was pulled in a direction vertical to the substrate. Reworkability was evaluated as follows:
◯: the moisture-proof insulating film was torn completely from the substrate without breakage, and no residue remained on the substrate;
Δ: the moisture-proof insulating film was torn from the substrate without breakage, but there is a minor amount of residue on the substrate;
X: the moisture-proof insulating film was torn from the substrate with breakage, and there is a great amount of residue on the substrate.

### 6. Adhesion:

Each of the coating compositions obtained in Examples 1 to 7 and Comparative Examples 1 to 5 was applied on a glass substrate of 750 mm×750 mm, and was then dried at 80° C. for 2 hours to form a moisture-proof insulating film on the glass substrate. The adhesion of the moisture-proof insulating film was detected using JIS K5400 testing method as follows. The moisture-proof insulating film was cut into an array of 10 grids×10 grids. A tape was adhered to the cut moisture-proof insulating film, and was then torn from the moisture-proof insulating film. The number of the grids that remained on the glass substrate was counted. The adhesion of the moisture-proof insulating film was evaluated as follows.

⊚: 90/100<R≦100/100;

◯: 80/100<R≦90/100;

Δ: 70/100<R 80/100;

X: 60/100<R≦70/100,

wherein R=a ratio of the number of the grids that remained on the glass substrate after tearing to the total grid number of the tested array.

TABLE 2

| Components | | Examples | | | | | | | Comparative Examples | | | | |
|---|---|---|---|---|---|---|---|---|---|---|---|---|---|
| (parts by weight) | | 1 | 2 | 3 | 4 | 5 | 6 | 7 | 1 | 2 | 3 | 4 | 5 |
| Block copolymer (A) | A-1 | — | — | — | — | — | — | — | 100 | — | — | — | — |
| | A-2 | 100 | — | — | — | — | — | — | — | — | — | 100 | — |
| | A-3 | — | 100 | — | — | — | — | — | — | — | — | — | — |
| | A-4 | — | — | 100 | — | — | — | 50 | — | — | — | — | — |
| | A-5 | — | — | — | 100 | — | — | 50 | — | — | — | — | — |
| | A-6 | — | — | — | — | 100 | — | — | — | — | — | — | — |
| | A-7 | — | — | — | — | — | 100 | — | — | — | — | — | — |
| | A-8 | — | — | — | — | — | — | — | — | 100 | — | — | — |
| | A-9 | — | — | — | — | — | — | — | — | — | 100 | — | — |
| | A-10 | — | — | — | — | — | — | — | — | — | — | — | 100 |
| Adhesive resin (B) | B-1 | 5 | — | — | 200 | 50 | — | 70 | 100 | — | 100 | — | — |
| | B-2 | — | 30 | — | — | 50 | 30 | — | — | 100 | — | — | — |
| | B-3 | — | — | 100 | — | — | 70 | 30 | — | — | — | — | 100 |
| Solvent (C) | C-1 | 50 | — | — | 800 | 1000 | 250 | 250 | 500 | 500 | 500 | 500 | 800 |
| | C-2 | — | 300 | — | — | — | 250 | 250 | — | — | — | — | — |
| | C-3 | — | — | 500 | — | — | — | — | — | — | — | — | — |
| Siloxane coupling | D-1 | — | — | — | — | 1 | — | — | — | — | — | 1 | — |
| agent (D) | D-2 | — | — | — | — | — | 2 | — | — | — | — | — | — |
| Additive (E) | E-1 | — | — | — | — | — | 1 | — | — | — | — | — | — |
| Evaluation results | Coating evenness | Δ | Δ | ◯ | ◯ | ◯ | ◯ | ◯ | ◯ | X | X | ◯ | ◯ |
| | Reworkability | ◯ | Δ | ◯ | ◯ | ◯ | ◯ | ◯ | X | ◯ | X | ◯ | X |
| | adhesion | Δ | ◯ | ◯ | ◯ | ⊚ | ⊚ | ◯ | ◯ | X | X | X | X |

A-10: methacrylic resin
B-1: Yasuhara Resin U130
B-2: Yasuhara Resin T145
B-3: Yasuhara Resin T160
C-1: cyclohexane
C-2: methylcyclohexane
C-3: ethylcyclohexane
D-1: KBM-602
D-2: KBM-503
E-1: silica

As shown in Table 2, in Comparative Example 1, the block copolymer contained in the coating composition has a hydrogenation ratio of 0%, and the reworkability of the moisture-proof insulating film formed from the coating composition is inferior. In Comparative Example 2, the block copolymer contained in the coating composition has a hydrogenation ratio of 95%, and the adhesion of the moisture-proof insulating film formed from the coating composition is inferior.

In Examples 1 to 7, the block copolymers contained in the coating compositions have hydrogenation ratios in a range from 10% to 90%, and the reworkability and the adhesion of the moisture-proof insulating films formed from the coating compositions are superior.

Furthermore, in Comparative Example 2, the block copolymer contained in the coating composition has a number average molecular weight of 120,000, and the coating evenness of the coating composition is inferior.

In Examples 3 to 7, the block copolymers contained in the coating compositions have number average molecular weights in a range from 50,000 to 100,000, and the coating evenness of the coating compositions is superior.

In Comparative Example 3, the block copolymer contained in the coating composition is composed of one vinyl aromatic polymer block and one partially hydrogenated conjugated diene polymer block. The coating evenness of the coating composition is inferior, and the moisture-proof insulating film formed from the coating composition has inferior reworkability and adhesion.

In Comparative Example 4, the coating composition does not contain adhesive resin, and the moisture-proof insulating film formed from the coating composition has inferior adhesion.

In Comparative Example 5, the coating composition contains a conventional methacrylic resin, and the moisture-proof insulating film formed from the coating composition has inferior reworkability.

Therefore, it has been demonstrated that improved coating evenness can be obtained using the coating composition of the present invention in which the hydrogenation ratio of the block copolymer contained in the coating composition is specifically controlled. Furthermore, the moisture-proof insulating film formed from the coating composition of the present invention has improved reworkability and adhesion.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A coating composition comprising:
a block copolymer,
an adhesive resin, and
a solvent for dispersing said block copolymer and said adhesive resin therein,
wherein said block copolymer contains at least two vinyl aromatic polymer blocks and at least one partially hydrogenated conjugated diene polymer block, and has a hydrogenation ratio ranging from 10% to 90%.

2. The coating composition as claimed in claim 1, wherein said hydrogenation ratio ranges from 15% to 85%.

3. The coating composition as claimed in claim 2, wherein said hydrogenation ratio ranges from 20% to 80%.

4. The coating composition as claimed in claim 1, wherein said block copolymer includes a vinyl aromatic monomer unit in an amount ranging from 15 wt % to 60 wt % based on 100 wt % of said block copolymer.

5. The coating composition as claimed in claim 1, wherein said block copolymer has a number average molecular weight ranging from 50,000 to 100,000.

6. The coating composition as claimed in claim 1, wherein said adhesive resin is in an amount ranging from 5 parts by weight to 200 parts by weight based on 100 parts by weight of said block copolymer.

7. The coating composition as claimed in claim 1, wherein said solvent is in an amount ranging from 50 parts by weight to 1000 parts by weight based on 100 parts by weight of said block copolymer.

8. The coating composition as claimed in claim 1, further comprising a siloxane coupling agent.

9. The coating composition as claimed in claim 8, wherein said siloxane coupling agent is in an amount ranging from 0.1 part by weight to 5 parts by weight based on 100 parts by weight of said block copolymer.

10. A moisture-proof insulating film formed from a coating composition as claimed in claim 1.

11. A moisture-proof insulating electronic device comprising a moisture-proof insulating film as claimed in claim 10.

12. A method for manufacturing a moisture-proof insulating electronic device, comprising the steps of:
coating a coating composition as claimed in claim 1 on an electronic device, and
drying the coating composition to form a moisture-proof insulating film on the electronic device.
